(19) United States
(12) Patent Application Publication
(10) Pub. No.: US 2023/0335816 A1
(43) Pub. Date: Oct. 19, 2023

(54) METHOD FOR SAFE RECOVERY OF A WASTE ANODE PIECE OF A LITHIUM ION BATTERY AND APPLICATION THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP VEHICLES RECYCLING CO., LTD., Changsha (CN)

(72) Inventors: Yinghao Xie, Foshan (CN); Haijun Yu, Foshan (CN); Changdong Li, Foshan (CN); Shumin Liu, Foshan (CN)

(73) Assignees: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP VEHICLES RECYCLING CO., LTD., Changsha (CN)

(21) Appl. No.: 18/212,178

(22) Filed: Jun. 20, 2023

Related U.S. Application Data
(63) Continuation of application No. PCT/CN2021/142799, filed on Dec. 30, 2021.

(30) Foreign Application Priority Data
Mar. 19, 2021 (CN) 202110295469.2

(51) Int. Cl. H01M 10/54; C22B 7/00; C22B 21/06; C22B 1/24

(52) U.S. Cl. CPC H01M 10/54; C22B 7/007; C22B 21/06; C22B 1/24

(57) ABSTRACT

The invention discloses a method and application for a safe recovery of waste anode pieces of lithium ion batteries. The method comprises the following steps: crushing and sieving the waste anode piece to obtain an anode powder A and a crushed aluminum slag; mixing the crushed aluminum slag with an acid solution, stirring under ultrasound, and then performing wet sieving to obtain an aluminum slag and a battery powder; the obtained aluminum slag is washed with water, then rinsed with an explosion suppressant, centrifuging to obtain an explosion suppressing aluminum slag, and then packed and compressed to obtain an aluminum slag block; connecting the two ends of the aluminum slag block to a positive plate and a negative plate of a DC electrode respectively, applying a current to melt the aluminum slag block, and cooling to obtain a safe aluminum slag block.

### CROSS-REFERENCE TO RELATED APPLICATIONS

The present application is a continuation application of PCT application No. PCT/CN2021/142799 filed on Dec. 30, 2021, which claims the benefit of Chinese Patent Application No. 202110295469.2 filed on Mar. 19, 2021. The contents of all of the aforementioned applications are incorporated by reference herein in their entirety.

### TECHNICAL FIELD

The invention belongs to the technical field of battery recycling, and specifically relates to a method and application for the safe recycling of waste pole pieces of lithium ion batteries.

### BACKGROUND

During a production process of lithium-ion batteries, a certain amount of waste pole pieces will be generated in the pole pieces production procedure. In the case of large-scale production of lithium-ion batteries, a large number of waste pole pieces will be produced. Waste pole pieces contain a lot of metal elements such as nickel, cobalt, manganese, lithium, etc. And they will pollute the environment if not recycled.

The traditional process of waste pole piece recovery is to crush the pole piece, which is then separated and sorted into aluminum slags and battery powder. The aluminum slag will be washed with acid, and separated again to obtain metal aluminum. Since the aluminum slag will have residual acid and moisture after washing, the separated aluminum slag will react with the residual acid and water, releasing hydrogen and generating heat. Hence the aluminum slag has the risk of burning and explosion when stored. At the same time, the battery powder obtained by separation and sorting contains residual metal aluminum. In a following acid leaching process, the residual metal aluminum will react with the acid to release hydrogen, exposing the acid leaching process under a risk of burning and explosion. The traditional production process has obvious limitations.

### SUMMARY OF THE INVENTION

The present invention aims to solve at least one of the technical problems existing in the above-mentioned prior art. For this reason, the present invention proposes a method and application for a safe recovery of waste pole pieces of lithium ion batteries. The method comprises steps of washing an aluminum slag with a saturated calcium hydroxide solution which then neutralizes the residual acid generated during the aluminum slag production process, so as to prevent hydrogen releasing and heat generation caused by a reaction between the aluminum slag and the residual acid, ensuring a storage safety.

In order to achieve the above objectives, the present invention comprises the following technical solutions:

A method for a safe recovery of a waste anode piece of lithium ion batteries comprises the following steps:
(1) crushing and screening the waste anode piece to obtain an anode powder A and a crushed aluminum slag;
(2) mixing the crushed aluminum slag and an acid solution, stirring under ultrasound, and then performing wet sieving to obtain an aluminum slag and a battery powder;
(3) washing the aluminum slag obtained in step (2) first with water, then with an explosion suppressant, centrifuging to obtain an explosion suppressing aluminum slag, and then packaging and compressing the explosion suppressing aluminum slag to obtain an aluminum slag block;
(4) connecting both two ends of the aluminum slag block to a positive plate and a negative plate of a DC electrode separately, applying a current to melt the aluminum slag, and cooling to obtain a safe aluminum slag block; in step (3), the explosion suppressant is a saturated calcium hydroxide solution.

Preferably, in step (2), the following steps are further included: filtering the battery powder and washing a resulting filter residue to obtain an anode powder B; mixing the anode powder A and the anode powder B, and then soaking and stirring a resulting mixture in an aluminum-dissolving solution, filtrating and washing a resulting residue to obtain an anode powder.

More preferably, the aluminum-dissolving solution is at least one selected from the group consisting of sodium hydroxide solution, potassium hydroxide solution and calcium hydroxide solution.

In a traditional process without a step of removing the residual aluminum from a battery powder, the residual aluminum and the battery powder directly enter an acid leaching process. In an actual production, in order to make the battery powder have a better dissolving effect, the acid leaching process performs with a high-concentration strong acid under a heating condition. During the leaching, the residual aluminum will react quickly with the leaching solution (high concentration strong acid), which then causes a large amount of hydrogen to fast accumulate in the leaching tank and reach an explosive concentration, making the leaching tank a safety risk of explosion.

The aluminum-dissolving solution is to dissolve the residual aluminum in the battery powder to prevent it from releasing hydrogen during the leaching process, so as to avoid burning or explosion. Although the operation of dissolving aluminum with alkali in the present invention releases hydrogen as well as the traditional leaching process, in the step of dissolving aluminum with alkali of the present invention the aluminum dissolution can be controlled to proceed slowly by reducing the concentration of the aluminum-dissolving solution, lowering the temperature or adjusting other conditions, thereby slowing down a hydrogen release and offering the hydrogen enough time and space to escape so that the hydrogen content will not reach an explosive concentration. The process will be intrinsically safe.

More preferably, a volume concentration of the aluminum-dissolving solution is 0.003-2 mol/L.

More preferably, the aluminum-dissolving solution has a temperature of 15-45° C.

Preferably, in step (1), the sieving is carried out with a screen with an aperture of 0.1-0.5 mm.

Preferably, in step (2), the acid is one of sulfuric acid, hydrochloric acid or nitric acid.

The purpose of the operation of washing the crushed aluminum slag with the acid solution is to slightly corrode the surface of the metal aluminum with acid. Battery powder is attached to the surface of an aluminum foils in an anode piece, and after removing the battery powder, the aluminum foils are recovered as aluminum slag. To slightly corroding the aluminum surface can ensure the battery powder attached fall off and separate. The reaction process is: 2Al+6H⁺=2Al³⁺+3H_{2↑.}

Preferably, in step (2), the solid-to-liquid ratio of the crushed aluminum slag to the acid solution is 1: (0.3-5) kg/L.

Preferably, in step (2), a concentration of the acid solution is 0.1-2 mol/L.

Preferably, in step (2), the stirring speed is 60-1000 r/min.

Preferably, in step (2), the mixing time is 0.5-60 min.

Preferably, in step (2), the reaction time is 10-30 min.

The purpose of adding the saturated calcium hydroxide solution is: after the aluminum slag is washed with acid (or even further washed with water after the acid), there will be residual acid on the surface of the aluminum slag (the further washing with water after the acid can only reduce the residual acid concentration rather than removing the residual acid completely), the residual acid will continue to react with the aluminum slag, and the reaction formula is: 2Al+6H⁺=2Al³⁺+3H₂↑. The reaction process releases hydrogen and generates heat at the same time. The obtained aluminum slag will be packaged and stored in large bags and during the process of packaging and storing, hydrogen will be released and heat is accumulated, which may cause the hydrogen to be ignited or even exploded.

By washing with saturated calcium hydroxide solution (or saturated calcium hydroxide solution rinsing), the residual acid on the aluminum slag reacts with the saturated calcium hydroxide solution, and the reaction formula is OH⁻+H⁺=H₂O. The residual acid on the aluminum slag formed during the production process is neutralized to avoid a reaction between the aluminum slag and the residual acid, thereby the release of hydrogen and heat generation are prohibited to avoid combustion and explosion, and ensure the safety of the storage process.

After rinsing with the saturated calcium hydroxide solution, there will be residual alkali on the surface of the aluminum slag. Because the saturated calcium hydroxide solution can react with carbon dioxide in the air, the residual alkali will be consumed while forming calcium carbonate at the same time. The generated calcium carbonate will coat the surface of the aluminum slag and prevent a further reaction between the aluminum slag and water. 2Al+6H₂O=2Al(OH)₃+3H₂.

Preferably, in step (3), the washing with water is carried out for 0.5-5 min, and the washing with the explosion suppressant is carried out for 0.5-5 min.

Preferably, in step (3), the pressure of the packing and compressing is 5-30 MPa.

Preferably, in step (4), the positive electrode plate or the negative electrode plate is a hollow circulating liquid-cooled metal plate; the metal is one of copper, silver, gold, copper-plated gold, or copper-plated silver.

Preferably, in step (4), the current is 80-500 A, and the test time is 0.5-5 s.

The composition of the aluminum slag block is metallic aluminum, and the shape is a metal block formed by sieving aluminum slag (aluminum foil with a particle size greater than 0.1-0.5 mm) and then being melted by a strong current at a high temperature.

Compared with the prior art, the beneficial effects of the present invention are as follows:
1. In the present invention the residual acid reacts with the saturated calcium hydroxide solution during washing with saturated calcium hydroxide solution, and the residual acid formed in the aluminum slag production process is neutralized so as to avoid the reaction between the aluminum slag and the residual acid, which prevents release of hydrogen and heat generation, and ensures storage safety.
2. Take advantage of the low solubility of calcium hydroxide to control the alkalinity of the washing liquid and avoid a large excess of residual alkali. After alkaline washing, the remaining small amount of lye can react with carbon dioxide in the air to form calcium carbonate. Calcium carbonate is insoluble in water and will wrap on the surface of the aluminum slag particles, preventing the residual acid/base and the aluminum slag from continuously reacting to release hydrogen and heat. The resulting calcium carbonate has a small particle size, which can effectively reduce the ignition probability of aluminum powder, has a strong anti-explosion effect, and can effectively inhibit the explosion of aluminum slag. Eliminate the possibility of fire or explosion due to stacking of aluminum slag, so that the produced aluminum slag has intrinsically safe properties.
3. Since the battery powder will enter the leaching process after recovery, the leaching process is leached with strong acids, such as sulfuric acid and hydrochloric acid. If the battery powder contains metallic aluminum, the leaching process may cause the metallic aluminum to react with strong acid and produce hydrogen gas, which may cause fire and explosion risks. The battery powder recovered by the present invention is added to the aluminum solution to selectively dissolve and separate the small amount of metal aluminum that may be brought into the battery powder due to crushing and separation, while avoiding the dissolution of other valuable metal elements such as nickel, cobalt, manganese and lithium. On the premise of eliminating potential safety hazards of battery powder, it can also ensure that valuable metals such as nickel, cobalt, manganese and lithium have a high recovery rate.
4. The present invention packs and compresses aluminum slag into blocks, greatly compresses the gap between the aluminum slag, reduces the specific surface area of the aluminum slag, reduces the reaction rate of the aluminum slag with residual alkali or with water, and effectively reduces the release of hydrogen. Make the aluminum slag achieve intrinsic safety.
5. The invention adopts the operation of compressing the aluminum slag into a block, and followed by applying a strong current to melt the aluminum slag into a whole. The inside of the aluminum slag block is composed of a large number of aluminum slag pieces. And when the aluminum pieces are pressed into an aluminum slag block there is a large contact resistance between the aluminum slag pieces in contact with each other. Under a current, a lot of heat is released between the aluminum slag pieces which are heated to melt. Some small particle sized aluminum slags are heated up quickly. The aluminum slag pieces inside the aluminum slag block form a state of mutual adhesion, so that the small particle sized aluminum slag and the aluminum slag piece are melted to combine with each other, the aluminum slag pieces are also melted and combined. The particle size of the aluminum slag is enlarged and the combustion activation energy the aluminum slag is increased to prevent spontaneous combustion of aluminum slag storage.
6. The present invention uses liquid-cooled hollow metal plates as the positive and negative plates. When the current passes through the plates, the plates temperature can be effectively maintained while the aluminum slag is cooled down, which can: 1. avoid an adhesion between the plates and the aluminum slag block when the plates are heated up; 2. avoid a reaction between the aluminum slag blocks and oxygen in the air caused by excessively high outer surface temperature of the aluminum slag blocks so as to avoid the aluminum blocks burning.

### DETAILED DESCRIPTION OF ILLUSTRATED EXAMPLES

Hereinafter, the concept of the present invention and the technical effects produced by it will be described clearly and completely with reference to the embodiments, so as to fully understand the purpose, features and effects of the present invention. Obviously, the described embodiments are only a part of the embodiments of the present invention, rather than all of them. Based on the embodiments of the present invention, other embodiments obtained by those skilled in the art without creative work belong to the scope of protection of the present invention.

### Example 1

The method for a recovery of a waste anode piece of lithium-ion batteries in this embodiment comprises the following specific steps:
(1) Crushing and sieving the waste anode piece to obtain an anode powder A and a crushed aluminum slag;
(2) Mixing the crushed aluminum slag with 0.1 mol/L sulfuric acid at a solid-to-liquid ratio of 1:5 kg/L, stirring under ultrasound at a stirring speed of 500 r/min for 60 min, to obtain a crushed aluminum slag after acid washing;
(3) preforming wet sieving to screen the crushed aluminum slag after acid washing, and the oversize from the acid solution is mainly an aluminum slag, and the undersize is mainly battery powder; filtering the undersize and washing with water to obtain an anode powder B;
(4) Mixing the anode powder A and anode powder B, adding 0.003 mol/L calcium hydroxide solution according to a solid-liquid ratio of 1:0.5 kg/L, soaking for 120 min, filtering, washing a resulting filter residue with water to obtain a safe type anode powder;
(5) Washing the aluminum slag obtained in step (3) with water for 0.5 min, then with saturated calcium hydroxide solution for 0.5 min, and drying a resulting product by centrifuging to obtain an explosion suppressing aluminum slag;
(6) Placing the explosion suppressing aluminum slag into a metal baler, packaging and compressing under a pressure of 5 MPa to obtain the aluminum slag block;
(7) Connecting two ends of the aluminum slag block to two DC electrode plates (hollow liquid-cooled copper plates) respectively, as a positive plate and a negative plate; applying 80 A current between the positive and negative plates for 5 s, and cooling to obtain a safe type aluminum slag block.

### Example 2

The method for a safe recovery of a waste anode piece of lithium-ion batteries in this embodiment comprises the following specific steps:
(1) Crushing and sieving the waste anode piece with a screen with an aperture size of 0.3 mm to obtain an anode powder A and a crushed aluminum slag;
(2) Mixing the crushed aluminum slag with 1 mol/L sulfuric acid at a solid-to-liquid ratio of 1:1 kg/L, stirring under ultrasound at a stirring speed of 500 r/min for 5 min, to obtain a crushed aluminum slag after acid washing;
(3) performing wet sieving to screen the crushed aluminum slag after acid washing, and the oversize from the acid solution is mainly an aluminum slag, and the undersize is mainly battery powder; filtering the undersize and washing with water to obtain an anode powder B;
(4) Mixing the anode powder A and anode powder B, adding 0.5 mol/L sodium hydroxide solution according to a solid-liquid ratio of 1:0.5 kg/L, soaking for 30 min, filtering, washing a resulting filter residue with water to obtain a safe type anode powder;
(5) Washing the aluminum slag obtained in step (3) with water for 1 min, then with saturated calcium hydroxide solution for 1 min, and drying a resulting product by centrifuging to obtain an explosion suppressing aluminum slag;
(6) Placing the explosion suppressing aluminum slag into a metal baler, packaging and compressing under a pressure of 10 MPa to obtain the aluminum slag block;
(7) Connecting two ends of the aluminum slag block to two DC electrode plates (hollow liquid-cooled copper plates) respectively, as a positive plate and a negative plate; applying 200 A current between the positive and negative plates for 2 s, and cooling to obtain a safe type aluminum slag block.

### Example 3

The method for a safe recovery of a waste anode piece of lithium-ion batteries in this embodiment comprises the following specific steps:
(1) Crushing and sieving the waste anode piece to obtain an anode powder A and a crushed aluminum slag;
(2) Mixing the crushed aluminum slag with 2 mol/L sulfuric acid at a solid-to-liquid ratio of 1:0.3 kg/L, stirring under ultrasound at a stirring speed of 500 r/min for 60 min, to obtain a crushed aluminum slag after acid washing;
(3) preforming wet sieving to screen the crushed aluminum slag after acid washing, and the oversize from the acid solution is mainly an aluminum slag, and the undersize is mainly battery powder; filtering the undersize and washing with water to obtain an anode powder B;
(4) Mixing the anode powder A and anode powder B, adding 2 mol/L potassium hydroxide solution according to a solid-liquid ratio of 1:2 kg/L, soaking for 1 min, filtering, washing a resulting filter residue with water to obtain a safe type anode powder;
(5) Washing the aluminum slag obtained in step (3) with water for 5 min, then with saturated calcium hydroxide solution for 5 min, and drying a resulting product by centrifuging to obtain an explosion suppressing aluminum slag;
(6) Placing the explosion suppressing aluminum slag into a metal baler, packaging and compressing under a pressure of 30 MPa to obtain the aluminum slag block;
(7) Connecting two ends of the aluminum slag block to two DC electrode plates (hollow liquid-cooled copper plates) respectively, as a positive plate and a negative plate; applying 500 A current between the positive and negative plates for 0.5 s, and cooling to obtain a safe type aluminum slag block.

### Comparative Example 1

The method for a safe recovery of waste anode pieces of lithium ion batteries of this comparative example comprises the following specific steps:
(1) After crushing the anode piece of the waste lithium-ion battery, sieving with a screen having an aperture of 0.5 mm, a resulting under-sieve is an anode powder;
(2) Mixing the oversize with 1 mol/L sulfuric acid for 1 min according to a solid-to-liquid ratio of 1:1 kg/L, filtering, washing with water and drying to obtain an aluminum slag of this comparative example.

### Comparative Example 2

The method for a safe recovery of a waste anode piece of lithium-ion batteries in this embodiment comprises the following specific steps:
(1) Crushing and sieving the waste anode piece to obtain an anode powder A and a crushed aluminum slag;
(2) Mixing the crushed aluminum slag with 0.1 mol/L sulfuric acid at a solid-to-liquid ratio of 1:5 kg/L, stirring under ultrasound at a stirring speed of 500 r/min for 60 min, to obtain a crushed aluminum slag after acid washing;
(3) Preforming wet sieving to screen the crushed aluminum slag after acid washing, and the oversize from the acid solution is mainly an aluminum slag, and the undersize is mainly battery powder; filtering the undersize and washing with water to obtain an anode powder B;
(4) Mixing the anode powder A and anode powder B, adding 0.003 mol/L calcium hydroxide solution according to a solid-liquid ratio of 1:0.5 kg/L, soaking for 120 min, filtering, washing a resulting filter residue with water to obtain a safe type anode powder;
(5) Washing the aluminum slag obtained in step (3) with water for 0.5 min, then with saturated sodium hydroxide solution for 0.5 min, and drying a resulting product by centrifuging to obtain an explosion suppressing aluminum slag;
(6) Placing the explosion suppressing aluminum slag into a metal baler, packaging and compressing under a pressure of 5 MPa to obtain the aluminum slag block;
(7) Connecting two ends of the aluminum slag block to two DC electrode plates (hollow liquid-cooled copper plates) respectively, as a positive plate and a negative plate; applying 80 A current between the positive and negative plates for 5 s, and cooling to obtain a safe type aluminum slag block.

### Comparative Example 3

The method for a safe recovery of a waste anode piece of lithium-ion batteries in this embodiment comprises the following specific steps:
(1) Crushing and sieving the waste anode piece to obtain an anode powder A and a crushed aluminum slag;
(2) Mixing the crushed aluminum slag with 0.1 mol/L sulfuric acid at a solid-to-liquid ratio of 1:5 kg/L, stirring under ultrasound at a stirring speed of 500 r/min for 60 min, to obtain a crushed aluminum slag after acid washing;
(3) Preforming wet sieving to screen the crushed aluminum slag after acid washing, and the oversize from the acid solution is mainly an aluminum slag, and the undersize is mainly battery powder; filtering the undersize and washing with water to obtain an anode powder B;
(4) Mixing the anode powder A and anode powder B, adding 0.003 mol/L calcium hydroxide solution according to a solid-liquid ratio of 1:0.5 kg/L, soaking for 120 min, filtering, washing a resulting filter residue with water to obtain a safe type anode powder;
(5) Washing the aluminum slag obtained in step (3) with water for 0.5 min, then with saturated calcium hydroxide solution for 0.5 min, and drying a resulting product by centrifuging to obtain an explosion suppressing aluminum slag;
(6) Placing the explosion suppressing aluminum slag into a metal baler, packaging and compressing under a pressure of 5 MPa to obtain the aluminum slag block;
(7) Connecting two ends of the aluminum slag block to two solid copper electrode plates respectively, as a positive plate and a negative plate; applying 80 A current between the positive and negative plates for 5 s, and cooling to obtain an aluminum slag block.

### Comparative Results

(1) The aluminum and battery powder recovered in the above-mentioned examples and comparative examples were used to calculate the metal recovery rate before and after the comparison treatment. The results are shown in Table 1. The small amount of metal aluminum that may be brought in by the crushing and sieving is selectively dissolved and separated, while avoiding the dissolution of other valuable metal elements such as nickel, cobalt, manganese, and lithium. This invention can also ensure a high recovery rate of valuable metals such as nickel, cobalt, manganese, lithium, etc., while eliminating the hidden dangers of battery powder.
(2) The aluminum slag recovered in the above examples and comparative examples were letting stand for 7 days to determine the hydrogen release rate per unit time; the battery powder recovered in the above examples and comparative examples were added to sulfuric acid to determine the hydrogen release rate per unit time per unit weight of the material. The results are shown in Table 2, indicating that when the aluminum slag was packed and compressed into blocks as in Examples 1-3, the gaps between the aluminum slags were greatly compressed, and the specific surface area of the aluminum slags were reduced. The reaction rate of the aluminum slag with residual alkali or with water was reduced so as to effectively reduce the inhibit hydrogen release and make the aluminum slag intrinsically safe. Comparative example 1 exhibits more higher hydrogen release. Comparative example 2 replaces saturated calcium hydroxide solution with saturated sodium hydroxide solution as an explosion suppressant, the aluminum slag still releases hydrogen.
(3) At a room temperature of 25° C., the aluminum slag recovered from the above examples and comparative examples was put into a ton bag and allowed to stand for 1 hour and 24 hours, respectively, and the temperature inside the aluminum slag was measured. The results are shown in Table 3.
(4) In Example 1-3, the two ends of the aluminum slag block were connected to two DC electrode plates (hollow liquid-cooled metal plates) respectively, and an electric current was applied. After cooling, a safe aluminum slag block was obtained. In Comparative Example 3, the two ends of the aluminum slag block were connected to two solid copper electrode plates respectively, and a current was applied. After cooling, an aluminum slag block was obtained. Measure the surface temperature of the aluminum slag and observe the adhesion between the electrode plate and the aluminum slag block. The results are shown in Table 4.

TABLE 1
Metal recovery rate

| | | | | Comparative |
|---|---|---|---|---|
| | Example1 | Example 2 | Example 3 | Example1 |
| | recovery | recovery | recovery | recovery |
| Metal | rate | rate | rate | rate |
| Al | 98.8% | 98.2% | 99.1% | 83.6% |
| Ni | 99.2% | 98.5% | 98.1% | 80.3% |
| Co | 99.5% | 99.6% | 99.2% | 82.7% |
| Mn | 98.7% | 99.2% | 98.8% | 76.9% |
| Li | 97.9% | 98.3% | 98.6% | 72.6% |

TABLE 2
Hydrogen release rate during the aluminum slag
storage and the battery powder leaching

| | | | | Compar- | Compar- |
|---|---|---|---|---|---|
| | | | | ative | ative |
| | Example 1 | Example 2 | Example 3 | Example 1 | Example 1 |
| | hydrogen | hydrogen | hydrogen | hydrogen | hydrogen |
| | release | release | release | release | release |
| Material | rate | rate | rate | rate | rate |
| Alumi- | 0 | 0 | 0 | 0.5 | 0.13 |
| num | | | | mg/(h · kg) | mg/(h · kg) |
| slag | | | | | |
| Battery | 0 | 0 | 0 | 3.3 | 0 |
| powder | | | | g/(min · kg) | |

TABLE 3
Temperature during the aluminum slag storage

| | | | | | | | Comparative | |
|---|---|---|---|---|---|---|---|---|
| | Example 1 | | Example 2 | | Example 3 | | Example 1 | |
| | temperature | | temperature | | temperature | | temperature | |
| Material | 1 h | 24 h | 1 h | 24 h | 1 h | 24 h | 1 h | 24 h |
| Aluminum | 32° C. | 26° C. | 35° C. | 25° C. | 30° C. | 25° C. | 85° C. | 72° C. |
| slag | | | | | | | | |

TABLE 4
Surface temperature and adhesion of the aluminum slag

| | | | | Comparative |
|---|---|---|---|---|
| Item | Example 1 | Example 2 | Example 3 | Example 3 |
| Surface | 88 | 92 | 81 | 156 |
| temperature of | | | | |
| the aluminum | | | | |
| slag/° C. | | | | |
| Adhesion | No adhesion | No adhesion | No adhesion | Part of the |
| | between the | between the | between the | aluminum |
| | aluminum | aluminum | aluminum | slag adhere |
| | slag and | slag and | slag and | to the |
| | the plates | the plates | the plates | plates |

The embodiments of the present invention have been described in detail above with reference to the accompanying drawings. However, the present invention is not limited to the above-mentioned embodiments. Within the scope of knowledge possessed by those of ordinary skill in the art, various modifications can be made without departing from the purpose of the present invention. Variety. In addition, in the case of no conflict, the embodiments of the present invention and the features in the embodiments can be combined with each other.

1. A method for a safe recovery of a waste anode piece of a lithium ion battery, comprising the following steps:
(1) crushing and sieving the waste anode piece to obtain an anode powder A and a crushed aluminum slag;
(2) mixing the crushed aluminum slag with an acid solution, stirring under ultrasound, and then performing wet sieving to obtain an aluminum slag and a battery powder;
(3) washing the aluminum slag obtained in step (2) first with water, then with an explosion suppressant; centrifuging to obtain an explosion suppressing aluminum slag, and then packaging and compressing the explosion suppressing aluminum slag to obtain an aluminum slag block;
(4) connecting two ends of the aluminum slag block to a positive plate and a negative plate of a DC electrode respectively, applying a current to melt the aluminum slag block, and cooling to obtain a safe aluminum slag block; wherein in step (3), the explosion suppressant is a saturated calcium hydroxide solution; in step (4), the positive plate or the negative plate is a circulating liquid-cooled hollow metal plate.

2. The method according to claim 1, wherein step (2) further comprises the following steps:
filtering the battery powder and washing a resulting filter residue to obtain an anode powder B;
mixing the anode powder A and the anode powder B, soaking and stirring a resulting mixture in an aluminum-dissolving solution, filtering, washing a resulting residue to obtain an anode powder.

3. The method according to claim 2, wherein the aluminum-dissolving solution is at least one selected from the group consisting of a sodium hydroxide solution, a potassium hydroxide solution and a calcium hydroxide solution.

4. The method according to claim 2, wherein a volume concentration of the aluminum-dissolving solution is 0.003-2 mol/L; and a temperature of the aluminum-dissolving solution is 15-45° C.

5. The method according to claim 1, wherein in step (2), the acid is one selected from the group consisting of sulfuric acid, hydrochloric acid and nitric acid.

6. The method according to claim 1, wherein in step (2), a solid-to-liquid ratio of the crushed aluminum slag to the acid solution is 1: (0.3-5) kg/L; wherein in step (2), a concentration of the acid solution is 0.1-2 mol/L.

7. The method according to claim 1, wherein in step (3), the aluminium slag is washed with water for 0.5-5 min and washed with the explosion suppressant for 0.5-5 min.

8. The method according to claim 1, wherein in step (4), the current is 80-500 A, and the current is applied for 0.5-5 s.

9. The method according to claim 1, wherein in step (4), the metal is one selected from the group consisting of copper, silver, gold, copper-plated gold and copper-plated silver.

10. Use of the method of claim 1 in metal recovery.

11. Use of the method of claim 2 in metal recovery.

12. Use of the method of claim 3 in metal recovery.

13. Use of the method of claim 4 in metal recovery.

14. Use of the method of claim 5 in metal recovery.

15. Use of the method of claim 6 in metal recovery.

16. Use of the method of claim 7 in metal recovery.

17. Use of the method of claim 8 in metal recovery.

18. Use of the method of claim 9 in metal recovery.
